(19) United States
(12) Patent Application Publication
(10) Pub. No.: US 2004/0094614 A1
(43) Pub. Date: May 20, 2004

(54) Bill payment method including attachable bar code

(76) Inventor: Richard V. Badagliacca, Garnerville, NY (US)

Correspondence Address: Michael J. Badagliacca, No. 301, 2311 N. 9th Street, Arlington, VA, 22201, US

(21) Appl. No.: 10/293,553

(22) Filed: Nov. 14, 2002

(51) Int. Cl. G06F 17/00

(52) U.S. Cl. 235/375

(57) ABSTRACT

A method of paying a debt. A creditor prepares a payment notice corresponding to the debt, which has a scannable portion including account information thereon. The debtor attaches the scannable unit to a payment instrument when paying the debt.

### BACKGROUND OF THE INVENTION

1. Field of the Invention

The present invention relates to a method of generating and paying a bill, and more particularly, to a method in which a bill includes payment information in the form of a bar code, to be attached to a check when the bill is paid.

2. Description of the Related Art

Conventionally, bills such as phone bills, electric bills, credit card bills, and loan payment notices are sorted according to account number. Referring to FIG. 1, a creditor generates the bill 100, which includes the account number 130, and sends the bill 100 to a debtor. Typically, the debtor pays the bill with a check 108. Since creditors such as utility companies receive a large number of checks 108, payments are sometimes not credited to the proper account due to inadvertent mishandling by the creditor. Thus, in order to ensure proper processing by the creditor, it is necessary for the debtor to write the account number 130 on the check, typically in a blank, or “memo” area 120 of the check 108.

The above method has the following disadvantages. First, it is inconvenient for the debtor to have to write the account number 130.

Furthermore, the debtor may inadvertently write the wrong account number 130, which will create errors and processing delays at the creditor side. Also, due to poor penmanship, the creditor may not be able to read the account number 130 written on the check 108. In either of these cases, the problem may be overcome by referring to a returned portion 102 of the bill 100, which often accompanies the check 108 and has the account number 130 printed thereon, sometimes in the form of a bar code 106. This returned portion 102 is detached from a records portion 104, which is kept by the debtor for his own personal records, until it is lost in a drawer somewhere or thrown out. However, since the proper account number 130 is not on the check 108, additional work is created by having to refer to the returned portion 102, which is separate from the check 108. A fastening means 110, such as a paper clip, may be used to attach the returned portion 102 and the check 108.

For the creditor, these disadvantages may result in delayed receipt of payment by the creditor. Additional bill processing costs are incurred due to the labor and machinery necessary to properly process payments which include both the check 108 and the returned portion 102. Thus, even though the creditor may scan the bar code 106 to speed up processing time, time is lost since the bar code 106 is on a different paper from the check 108. Also, the size of the returned portion 102 obscures information on the check 108.

For the debtor, these disadvantages result in lost time, additional aggravation, and inadvertently missed payments.

### SUMMARY OF THE INVENTION

Accordingly, it is an object of the present invention to provide a bill payment method which overcomes the above disadvantages of the conventional method.

Additional objects and advantages of the invention will be set forth in part in the description which follows and, in part, will be obvious from the description, or may be learned by practice of the invention.

The foregoing an other objects of the invention are achieved by providing a method, including preparing a payment notice corresponding to a debt, the payment notice including a first portion including information regarding the debt, the first portion being self-attachable to a payment instrument.

The foregoing an other objects of the invention are also achieved by providing a method, including generating an account corresponding to a debt owed to a creditor by a debtor; generating a payment notice corresponding to the account, the payment notice including a first portion including information corresponding to the account, and a second portion attached to the first portion; preparing a payment instrument to pay the debt; detaching the first portion from the payment notice; and self-attaching the first portion to the payment instrument.

The foregoing an other objects of the invention are also achieved by providing an apparatus, including a first side, including information regarding a debt and self-attachable to a payment instrument to pay the debt.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a diagram of a conventional bill according to the present invention;

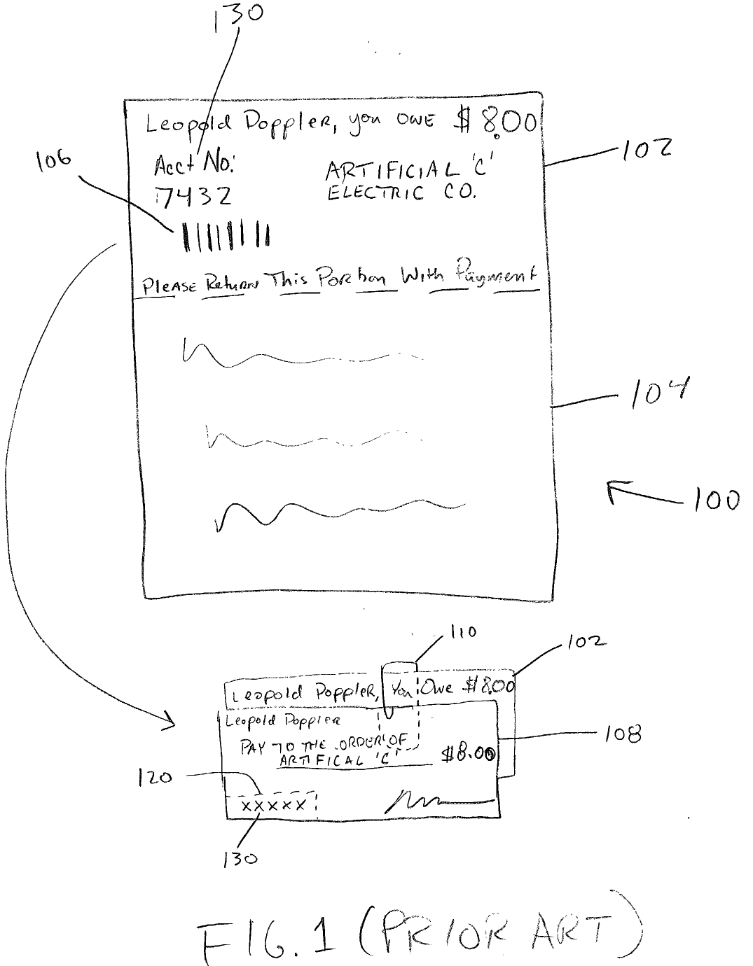

FIG. 2 is a diagram of a payment notice 10 according to the present invention; and

FIG. 3 is a flow diagram illustrating a method according to the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

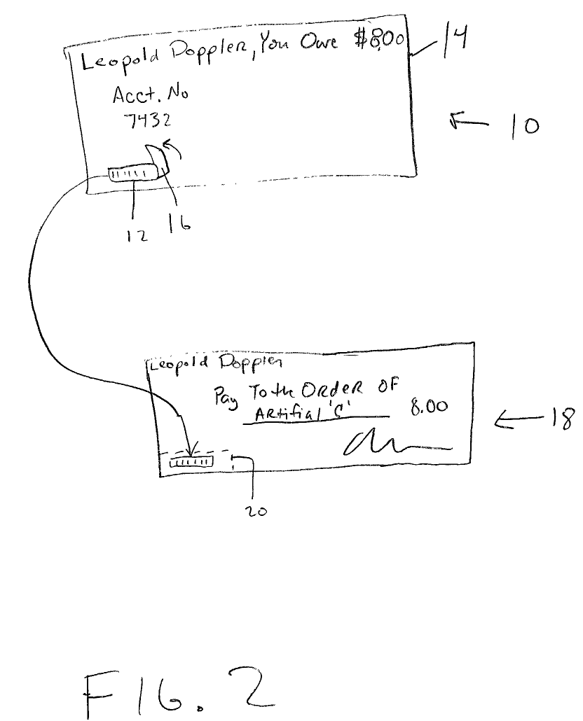

FIG. 2 is a diagram of a payment notice 10, such as a bill, according to the present invention. The payment notice 10 includes a first portion 12 which is detachable from a second portion 14. The first portion includes information 12 regarding a debt owed to a creditor. The information 12 may be an account number, an amount due, a due date, other information, or any combination of these types of information. The information 12 may be in the form of a bar code (as illustrated) to facilitate scanning or deter fraud, however, the information may also be in plain text, which may also be scanned by the appropriate apparatus (not shown).

The first portion 12 is easily removable from the second portion 14, and is self-attachable to a payment instrument 18, for example, a bill or a money order. “Self-attachable” means the first portion may be easily attached without any additional or external device. For example, the first portion 12 may be a label including a glue or other adhesive backing 16 to attach first portion 12 to the payment instrument 18. Other methods of self-attaching would be readily understood. The payment instrument may include a blank portion, for example, a “memo” portion 20. The first portion 12 is small enough to fit in the memo portion 20 and thus does not obscure the information printed on the remainder of the payment instrument 18. The second portion 14 may be retained for the debtors records, or used for other purposes such as paper airplanes or kindling.

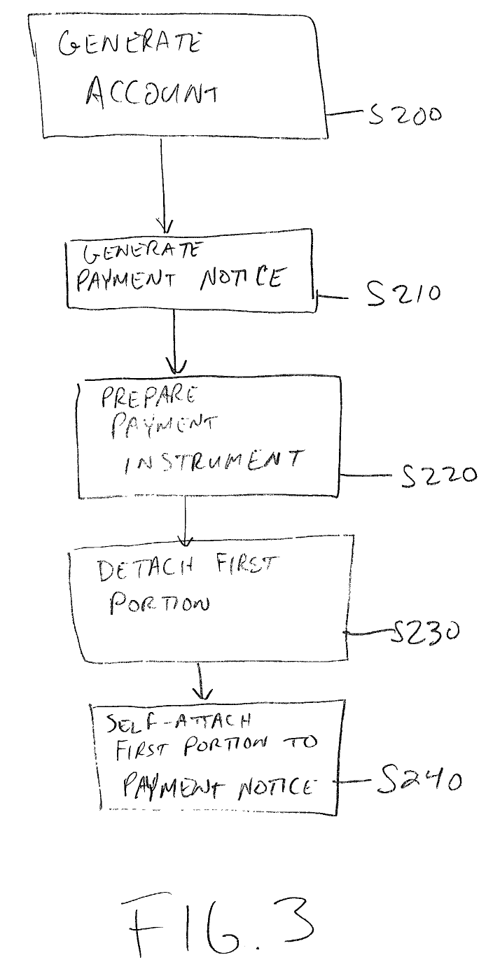

FIG. 3 is a flow diagram illustrating a method according to the present invention. The creditor generates an account corresponding to the debt (S200), and generates the payment notice 10 corresponding to the debt (S210). The debtor prepares the payment instrument 18 (S220), and detaches the first portion 12 from the second portion 14 (S230). The debtor then self-attaches the first portion 12 to the payment notice 18.

For the debtor, the present application is more convenient as compared to the conventional method, since it is not necessary to write a lengthy and easily forgettable account number. For the creditor, processing speed is increased because the payment information is in an easily scannable form. Furthermore, all of the necessary information is on a single piece of paper, and the information on the payment information is not obscured.

Although a few preferred embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A method, comprising:
preparing a payment notice corresponding to a debt, the payment notice including a first portion including information regarding the debt, the first portion being self-attachable to a payment instrument.

2. The method of claim 2, further comprising:
paying the debt by attaching the first portion to a payment instrument.

3. The method of claim 2, wherein the attaching includes attaching with an adhesive provided on the first portion.

4. The method of claim 1, wherein the payment notice further has a second portion, detachable from the first portion.

5. A method, comprising:
generating an account corresponding to a debt owed to a creditor by a debtor;
generating a payment notice corresponding to the account, the payment notice including a first portion including information corresponding to the account, and a second portion attached to the first portion;
preparing a payment instrument to pay the debt;
detaching the first portion from the payment notice; and
self-attaching the first portion to the payment instrument.

6. The method of claim 5, further comprising scanning the first portion to associate the payment instrument with the account.

7. The method of claim 5, wherein the self-attaching comprises attaching the first portion only to a blank portion of the payment instrument.

8. The method of claim 5, wherein the payment instrument is a bill.

9. The method of claim 5, wherein the first portion is a label.

10. The method of claim 5, wherein the information on the first portion comprises a bar code.

11. The method of claim 5, wherein the information on the first portion comprises an account number, an amount due, or a due date corresponding to the account.

12. The method of claim 5, wherein the first portion comprises an adhesive, and the self-attaching comprises attaching the first portion to the payment instrument with an adhesive.

13. An apparatus, comprising:
a first side, including information regarding a debt and self-attachable to a payment instrument to pay the debt.

14. The apparatus of claim 13, further comprising a second side, including an attaching portion to attach the apparatus to the payment instrument.

15. The apparatus of claim 14, wherein the attaching portion is an adhesive.

16. The apparatus of claim 13, wherein the information is scannable.

17. The apparatus of claim 16, wherein the information comprises a bar code.

18. The apparatus of claim 13, wherein the apparatus is attachable to the payment instrument without any external means of attachment.
